(19) United States
(12) Patent Application Publication
(10) Pub. No.: US 2015/0222005 A1
(43) Pub. Date: Aug. 6, 2015

(54) SATELLITE ALIGNMENT SYSTEM USING AUTOMATIC CONTROL OF OUTPUT POWER

(71) Applicant: BROADCOM CORPORATION, Irvine, CA (US)

(72) Inventors: Steven Jaffe, Irvine, CA (US); Pascal Finkenbeiner, Torrance, CA (US); Ronald Chan, Aliso Viejo, CA (US)

(73) Assignee: BROADCOM CORPORATION, Irvine, CA (US)

(21) Appl. No.: 14/613,061

(22) Filed: Feb. 3, 2015

Related U.S. Application Data
(60) Provisional application No. 61/935,501, filed on Feb. 4, 2014.

(51) Int. Cl. H01Q 1/12

(52) U.S. Cl. CPC H01Q 1/1257

(57) ABSTRACT

Systems and methods for use in evaluating a position of a satellite dish are provided. One system includes an antenna configured to receive an input satellite signal at a current position of a satellite dish and automatic gain control circuitry configured to apply a variable gain to the input satellite signal to produce a modified signal at a desired level. The system further includes power control circuitry configured to generate an output signal using the modified signal. The power control circuitry is configured to adjust a power level of the output signal using the variable gain applied to the input satellite signal such that the output signal is proportional to the input signal.

### CROSS-REFERENCE TO RELATED APPLICATIONS

The present application claims priority to and the benefit of U.S. Provisional Patent Application No. 61/935,501, titled “SATELLITE ALIGNMENT SYSTEM USING AUTOMATIC CONTROL OF OUTPUT POWER,” filed Feb. 4, 2014, which is incorporated herein by reference in its entirety.

### BACKGROUND

In recent years, transmission of data via satellite has increased considerably. Accordingly, when a satellite company wants to install a personal satellite dish on a customer's roof, an installer has to align the antenna of the dish with a satellite orbiting in the sky. For successful alignment, the antenna should be positioned in direct line of sight with the satellite. Since the satellite is in geosynchronous orbit, there is a narrow beamwidth to which to position the antenna. If the positioning of the antenna is off by a degree or so, the signal received from the satellite will lose signal quality and degrade.

Therefore, during installation, an installer observes a signal strength parameter that he or she is trying to optimize as the installer adjusts positioning of the antenna. In conventional processes, the outdoor unit for the satellite dish is set to an alignment mode, where a gain of the LNA (low noise amplifier) or LNB (low noise block downconverter) of the satellite dish is fixed at the front end. Therefore, if the installer is far off in pointing (the antenna) in line with the satellite, the signal quality will be poor and it will be difficult to determine the nature of the problem with the signal quality. Conversely, if the installer is close to positioning the antenna in line with the satellite, the received signal may be strong and become distorted. It may be difficult to determine that the alignment of the antenna is proper based on the distorted signals being observed.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram of a satellite dish alignment system in accordance with some embodiments of the present disclosure;

FIG. 2 is a diagram of a satellite dish alignment system in accordance with some embodiments of the present disclosure;

FIG. 3 is a block diagram of automatic gain circuitry and power control circuitry in accordance with some embodiments of the present disclosure;

FIG. 4 is a flowchart diagram demonstrating a methodology for controlling output power of a signal based on input power in accordance with some embodiments of the present disclosure; and

FIG. 5 is a flowchart diagram demonstrating a methodology for aligning a satellite dish by controlling output power of a signal based on input power in accordance with some embodiments of the present disclosure.

### DETAILED DESCRIPTION

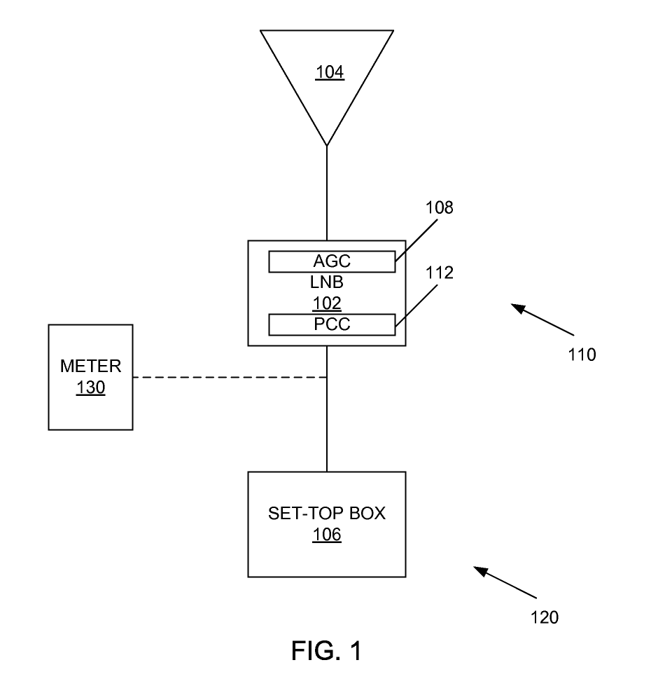

With reference to FIG. 1, shown is a satellite alignment system 100 in accordance with some embodiments of the present disclosure. In one embodiment, the satellite alignment system 100 includes a low noise block downconverter (LNB) 102 (or LNA) as part of the outdoor unit for use in a Direct Broadcast Satellite (DBS) television system. An antenna or satellite dish 104 is configured to receive a satellite transmission. In the outdoor unit, the satellite transmission received by the antenna 104 is coupled to the LNB 102 mounted to the antenna 104. In one embodiment, the LNB 102 downconverts the satellite transmission to an intermediate frequency (IF), by way of example, 950 to 2150 MHz. The LNB 102 may include any number of amplifier stages and filters to provide an IF signal with increased gain and reduced front end noise to a set-top box 106 for a television receiver or monitor inside a home.

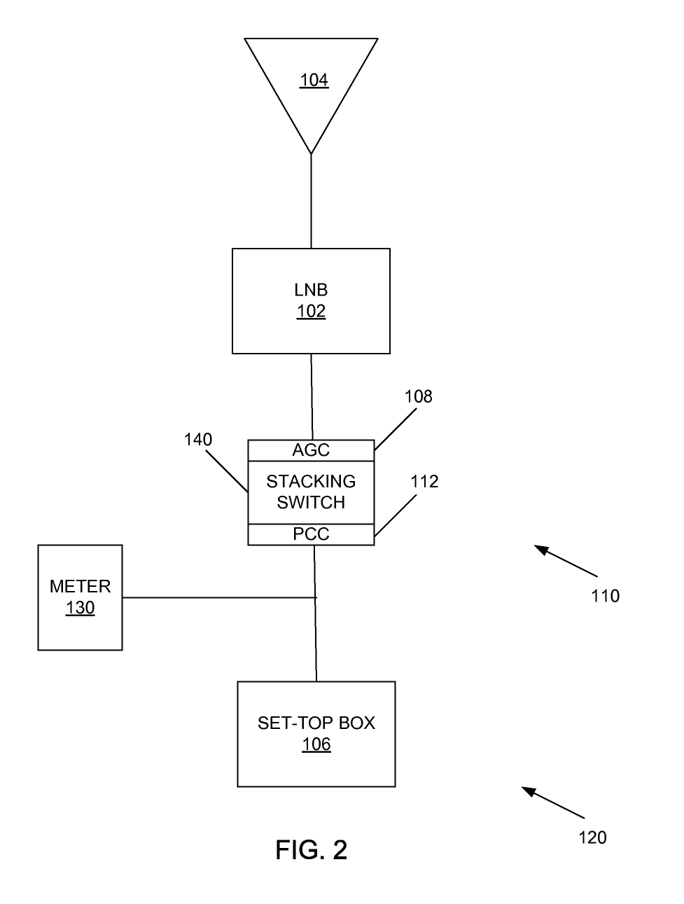

In some embodiments, the transmission received by the one or more satellite receiving antennas 104 is converted by an outdoor unit (ODU) 110 for transmission to one or more indoor units (IDUs) 120. The one or more IDUs 120 decode the transmission from the ODU 110 for delivery to the one or more end users. In one embodiment, the ODU 110 is integrated with the antenna or satellite dish and includes automatic gain control circuitry (AGC) 108 and power control circuitry (PCC) 112. In an alternative embodiment, AGC 108 and PCC 112 are integrated in an RF channel stacking switch 140 that is deployed between the LNB 102 of the satellite dish and the IDU 120, as represented in FIG. 2. In various embodiments, the AGC 108, the PCC 112, the LNB 102, and/or components thereof may be integrated within the ODU 110, the IDU 120, and/or within another device located inside or outside a building.

In some embodiments, the LNB 102 comprises low noise amplifiers, filters, and a frequency converter block. The amplifiers amplify the communications channels embedded within the received signal to provide an amplified communications signal. The converter block performs frequency downconversion on a received signal forming a composite signal having plural frequency bands, which is often referred to as a “band-stacked signal.”

For installation of the satellite dish 104, an installer may utilize a signal meter 130 that is connected to the LNB 102. Alternatively, the installer may utilize the set-top box 106 to monitor signal strength. For installation, the LNB 102 is signaled to enter an alignment mode to provide a signal for measuring the signal strength by the signal monitor or set-top box 106. In some embodiments, the LNB 102 or a device connected ( ) to the LNB 102 generates a signal based on the generated output signal that is used to evaluate a position of the satellite dish 104.

In some embodiments, for the alignment mode, automatic gain control circuitry (AGC) 108 of the LNB 102 is utilized on the received signal. In some embodiments, the AGC 108 operates during both alignment mode and normal or regular mode. A purpose of the AGC 108 is to hold the signal near a particular level (e.g., at a substantially constant level) so that it is not too big or not too small so that the set-top box 106 is not starved or distorted. Therefore, the AGC 108 will change the gain applied to the signal based on the strength of the input signal. In some embodiments, the AGC 108 varies the variable gain across a range of input signal levels to produce a modified signal at a substantially constant desired level, such that the level does not substantially change (e.g., stays within a threshold amount of the desired level) as the input signal varies across the range of input signal levels.

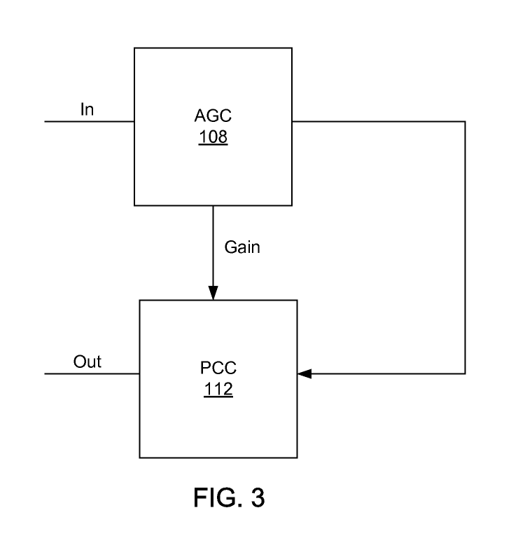

By monitoring the gain value being applied to a received signal, a determination may be made as to how much input signal power is being received by PCC 112. In response, the PCC 112 is configured to vary an output power of the output signal based on the AGC 108 level or gain value. In some embodiments, the PCC 112 generates the output power such that the power level of the output signal is directly proportional to the input level (e.g., in a one-to-one relationship, such that each output power level corresponds to a different, single input level). In one embodiment, PCC 112 may be a type of automatic power control (APC) circuitry that adjusts the power level based on the applied gain of the AGC 108. The output signal may then be received by the signal meter 130 or set-top box 106. A representation of operation of the AGC 108 and PCC 112 is shown in FIG. 3, for one embodiment.

As a result, in some embodiments, the satellite alignment system 100 has the capability to keep an input signal quality constant and vary the output power signal in direct proportion to the input power. In other words, since signal quality is a function of the input AGC or gain levels of the AGC 108, the PPC 112 can vary the output level and maintain the signal quality (e.g., keep it constant) as positioning of the antenna or dish 104 may change. In some embodiments, an installer can then measure a signal to noise ratio (SNR) over a full dynamic range of the received signal while its power is optimized. With the modification/optimization of the power, he/she has much better ability to discern small movements of the antenna 104 and how it affects signal quality and pointing accuracy of the antenna 104.

As an example and non-limiting comparative illustration, consider utilizing an alignment mode with non-fixed AGC value in accordance with the present disclosure. Here, an input signal can be applied as an input, and the input signal can sweep from the smallest input power to the largest input power. The output power will vary linearly (in dB) as the input power is changed without significant distortion.

Next, for comparative analysis, consider utilizing an alignment mode with a fixed AGC value. Again, an input signal can be applied as an input, and the input signal can sweep from the smallest input power to the largest input power. Then, the output power will, at some input power levels, experience severe distortion (e.g., the output power will no longer vary linearly (in dB) with the output signal). It is noted that this presence of distortion is not evident in the earlier example utilizing a technique of the present disclosure.

In some embodiments, the AGC 108 determines a difference between the input satellite signal level and a desired target level and varies the variable gain applied to the signal to produce a modified signal at the target level. For example, if the AGC 108 detects that the input signal is 5 dB below a target level, the AGC 108 can apply a 5 dB gain to the input signal. The PCC 112 adjusts (e.g., increases) a power level of the modified signal to generate an output signal. The PCC 112 determines (e.g., receives) the variable gain previously applied to generate the modified signal and adjusts the power level of the generated output signal to account for the gain applied (e.g., by applying a gain at the output stage). In the example above, the PCC 112 can adjust the level of the output signal down by 5 dB to account for the 5 dB variable gain applied by the AGC 108.

In some embodiments, the output signal of the PCC 112 is used to evaluate a current position of the satellite dish 104 and, optionally, adjust the position of the satellite dish 104 to obtain a better signal. In some embodiments, the PCC 112 or a device connected to the PCC 112 generates the output signal in a format for displaying a representation of the output power level on a display device (e.g., the signal meter 130, a display connected to the set-top box 106, etc.). In some embodiments, the PCC 112, or a device connected to the PCC 112, generates the output signal in a format for generating an audible indication of the output power level or signal strength (e.g., by transmitting the output data to a device including a speaker).

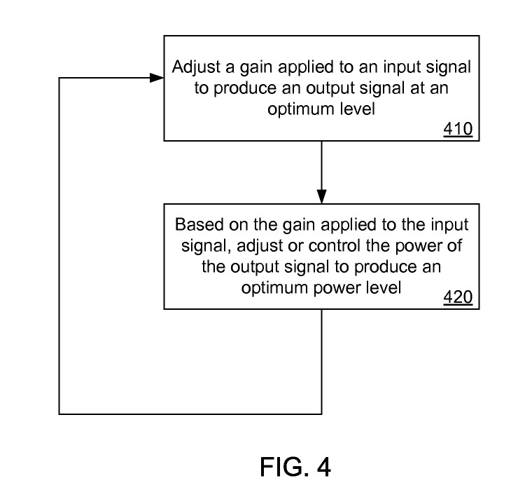

Referring now to FIG. 4, a flowchart demonstrating a methodology of controlling output power of a signal based on input power of the signal is depicted in accordance with some embodiments. In some embodiments, AGC 108 adjusts (410) a gain applied to an input signal to produce an output signal. The signal has a modified level as compared to the input signal (e.g., an optimum level). It is noted that the optimum level may be a predetermined voltage level, in some embodiments. Based on the gain applied to the input signal, PCC 112 adjusts or controls (420) the power of the output signal to produce an optimum or desired power level without sacrificing signal quality. The process may then repeat to control the output power as the gain of the AGC changes.

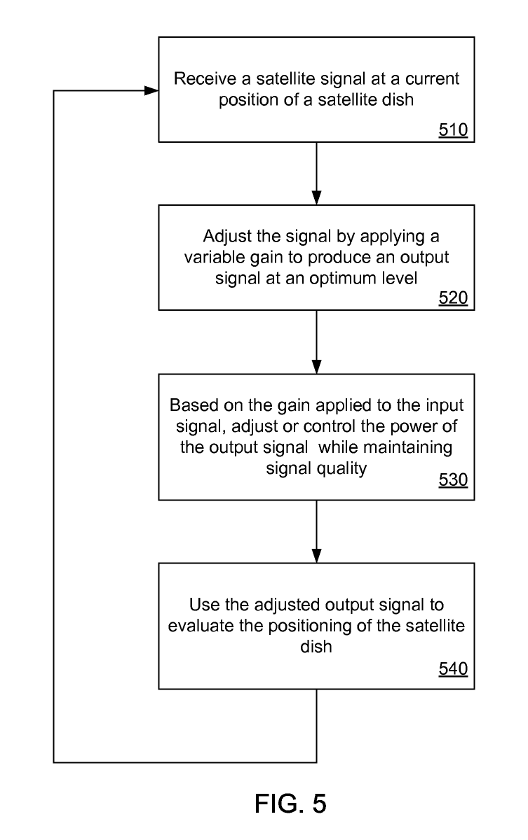

Next, FIG. 5 is a flowchart demonstrating a methodology of aligning a satellite dish or antenna 104 by controlling output power of a signal based on input power of the signal in accordance with some embodiments. In some embodiments, a satellite signal is received (510) at a current position of a satellite dish 104. The signal is adjusted (520) (e.g., via AGC 108) by applying a variable gain to produce an output signal at a desired (e.g., optimum) level. The optimum level may be a predetermined voltage level. Based on the gain applied to the input signal, PCC 112 adjusts or controls (530) the power of the output signal (to an optimum or desired level) while maintaining or not affecting signal quality. The adjusted output signal is used to evaluate (540) the positioning of the satellite dish 104. The process may then repeat to control the output power as the gain of the AGC changes.

In some embodiments, a system includes an antenna configured to receive an input satellite signal at a current position of a satellite dish and AGC configured to apply a variable gain to the input satellite signal to produce a modified signal at a desired level. The system further includes PCC configured to generate an output signal using the modified signal. The PCC is configured to adjust a power level of the output signal using the variable gain applied to the input satellite signal such that the output signal is proportional to the input signal.

In some embodiments, a method includes receiving an input satellite signal at a current position of a satellite dish; applying a variable gain to the input satellite signal to produce a modified signal at a desired level; and generating an output signal using the modified signal by adjusting a power level of the output signal using the variable gain applied to the input satellite signal such that the output signal is proportional to the input signal.

In some embodiments, a system includes one or more circuits configured to: receive an input satellite signal at a current position of a satellite dish from an antenna; apply a variable gain to the input satellite signal to produce a modified signal at a desired level, the variable gain varied such that the desired level is constant across a range of levels of the input satellite signal; and generate, using the modified signal, an output signal for evaluating the current position of the satellite dish while maintaining a signal quality of the input satellite signal, wherein the power control circuitry is configured to adjust a power level of the output signal using the variable gain applied to the input satellite signal such that the output signal is proportional to the input signal.

The disclosure is described above with reference to drawings. These drawings illustrate certain details of specific embodiments that implement the systems and methods and programs of the present disclosure. However, describing the disclosure with drawings should not be construed as imposing on the disclosure any limitations that may be present in the drawings. The present disclosure contemplates methods, systems and program products on any machine-readable storage media for accomplishing its operations. The embodiments of the present disclosure may be implemented using an existing computer processor, or by a special purpose computer processor incorporated for this or another purpose. No claim element herein is to be construed as a “means plus function” element unless the element is expressly recited using the phrase “means for.” Furthermore, no element, component or method step in the present disclosure is intended to be dedicated to the public, regardless of whether the element, component or method step is explicitly recited in the claims.

Embodiments within the scope of the present disclosure include machine-readable storage media for carrying or having machine-executable instructions or data structures stored thereon. Such machine-readable storage media can be any available media that can be accessed by a general purpose or special purpose computer or other machine with a processor. By way of example, such machine-readable storage media can include RAM, ROM, EPROM, EEPROM, CD ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable storage media. Machine-executable instructions include, for example, instructions and data which cause a general purpose computer, special purpose computer, or special purpose processing machine to perform a certain function or group of functions. Machine or computer-readable storage media, as referenced herein, do not include transitory media (i.e., signals in space).

Embodiments of the disclosure are described in the general context of method steps which may be implemented, in some embodiments, by a program product including machine-executable instructions, such as program code, for example, in the form of program modules executed by machines in networked environments. While the embodiments have been described above in the context of the satellite systems, it should be appreciated that the embodiments of this invention are not limited for use with only this one particular type of system, and that they may be used to advantage in other types of systems as well.

It should be noted that although the flowcharts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the disclosure.

The foregoing description of embodiments of the disclosure have been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated.

What is claimed is:

1. A system, comprising:
an antenna configured to receive an input satellite signal transmitted to a satellite dish;
automatic gain control circuitry configured to apply a variable gain to the input satellite signal to produce a modified signal at a desired level; and
power control circuitry configured to generate an output signal using the modified signal, wherein the power control circuitry is configured to adjust a power level of the output signal using the variable gain applied to the input satellite signal to control the output signal to be proportional to the input signal.

2. The system of claim 1, wherein the automatic gain control circuitry is configured to vary the variable gain to control the desired level to be constant across a range of levels of the input satellite signal.

3. The system of claim 2, wherein, for each level within the range of levels of the input satellite signal, the power control circuitry is configured to generate the output signal at a different power level to cause each power level of the output signal to correspond to a particular level of the input satellite signal.

4. The system of claim 1, wherein the power control circuitry is further configured to generate the output signal in a format configured for evaluating the current position of the satellite dish.

5. The system of claim 4, wherein the power control circuitry is configured to generate data using the power level of the output signal, wherein the data is configured for display on a display device for evaluating the current position of the satellite dish.

6. The system of claim 5, wherein the power control circuitry is configured to transmit the data to at least one of a signal meter or a set-top box.

7. The system of claim 1, wherein the desired level comprises a predetermined voltage level.

8. The system of claim 1, wherein the power control circuitry is configured to increase a power level of the modified signal to generate the output signal while maintaining a signal quality of the input satellite signal.

9. A method, comprising:
receiving an input satellite signal transmitted to a satellite dish;
applying a variable gain to the input satellite signal to produce a modified signal at a desired level; and
generating an output signal using the modified signal by adjusting a power level of the output signal using the variable gain applied to the input satellite signal to control the output signal to be proportional to the input signal.

10. The method of claim 9, further comprising varying the variable gain to control the desired level to be constant across a range of levels of the input satellite signal.

11. The method of claim 9, wherein generating the output signal comprises generating the output signal in a format configured for evaluating the current position of the satellite dish.

12. The method of claim 11, wherein generating the output signal comprises generating data using the power level of the output signal, wherein the data is configured for display on a display device for evaluating the current position of the satellite dish.

13. The method of claim 12, further comprising transmitting the data to at least one of a signal meter or a set-top box.

14. The method of claim 11, further comprising evaluating the current position of the satellite dish using the output signal.

15. The method of claim 9, wherein the desired level comprises a predetermined voltage level.

16. The method of claim 9, wherein generating the output signal comprises increasing a power level of the modified signal to generate the output signal while maintaining a signal quality of the input satellite signal.

17. A system, comprising:
one or more circuits configured to:
receive an input satellite signal transmitted to a satellite dish;
apply a variable gain to the input satellite signal to produce a modified signal at a desired level, the variable gain varied to control the desired level to be constant across a range of levels of the input satellite signal; and
generate, using the modified signal, an output signal for evaluating the current position of the satellite dish while maintaining a signal quality of the input satellite signal, wherein the power control circuitry is configured to adjust a power level of the output signal using the variable gain applied to the input satellite signal to control the output signal to be proportional to the input signal.

18. The system of claim 17, wherein the one or more circuits are configured to generate data using the power level of the output signal, wherein the data is configured for display on a display device for evaluating the current position of the satellite dish.

19. The system of claim 18, wherein the one or more circuits are configured to transmit the data to at least one of a signal meter or a set-top box.

20. The system of claim 17, wherein the desired level comprises a predetermined voltage level.
